(19) United States
(12) Patent Application Publication
(10) Pub. No.: US 2018/0376350 A1
(43) Pub. Date: Dec. 27, 2018

(54) RADIO COMMUNICATION SYSTEM AND BASE STATION DEVICE

(71) Applicant: SHARP KABUSHIKI KAISHA, Sakai City, Osaka (JP)

(72) Inventors: HIROMICHI TOMEBA, Sakai City (JP); TOMOKI YOSHIMURA, Sakai City (JP)

(21) Appl. No.: 15/776,479

(22) PCT Filed: Sep. 15, 2016
(86) PCT No.: PCT/JP2016/077213

§ 371 Date: May 16, 2018

(30) Foreign Application Priority Data
Nov. 20, 2015 (JP) 2015-227482

(51) Int. Cl. H04W 24/02; H04W 74/08

(52) U.S. Cl. CPC H04W 24/02; H04W 92/20; H04W 74/0816

(57) ABSTRACT

A radio communication system realizing flexible QoS control is provided. A radio communication system according to an aspect of the present invention includes multiple base station devices, each of the multiple base station devices including a reception unit configured to exert a carrier sense function. The multiple base station devices include first base station devices and second base station devices. Each of the first base station devices includes a control unit configured to acquire a first radio parameter common to the first base station devices. Each of the second base station devices includes a control unit configured to acquire a second radio parameter common to the second base station devices. First communication quality provided by the first radio parameter is different from second communication quality provided by the second radio parameter.

### TECHNICAL FIELD

The present invention relates to a radio communication system and a base station device.

### BACKGROUND ART

The Institute of Electrical and Electronics Engineers Inc. (IEEE) has formulated IEEE 802.11ac, which realizes a further increase in communication speed compared to IEEE 802.11, which refers to a wireless Local Area Network (LAN) standard. An effort to standardize IEEE 802.11 ax as a successor standard to IEEE 802.11ac has been started. With rapid prevalence of wireless LAN devices, for standardization of IEEE 802.11ax, an effort has been made to increase throughput per user in an environment overcrowded with wireless LAN devices.

The IEEE 802.11ax standard specifies the need for backward compatibility with the existing IEEE 802.11 standard. This suggests that the IEEE 802.11 ax standard also needs to support an access scheme based on CSMA/CA. However, the CSMA/CA, which requires carrier sense before transmission, poses a problem in that, in the overcrowded environment as illustrated above, possible interference between terminal devices may lead to a significant reduction in communication opportunities. Thus, a change in a threshold (CCA level, CCA threshold) for clear channel assessment (CCA) through carrier sense has recently been discussed which change is intended to increase communication opportunities while allowing for a certain level of interference (NPL 1 and the like). The terminal devices stop communication in a case of measuring interference of a CCA level or higher through carrier sense, and are thus less likely to miss communication opportunities by increasing the CCA level even in the overcrowded environment. Each of the terminal devices can also increase communication opportunities for other terminal devices in the overcrowded environment by using, as transmit power, power lower than prescribed transmit power.

Furthermore, for a cellular system, a communication method has been examined that increases communication capacity by realizing an improvement in desired signal power and a reduction in interference signal power through coordinated beamforming, in which multiple base station devices cooperate with one another in beamforming. This technique is of course applicable to a wireless LAN system, and e.g., NPL 2 discusses coordinated beamforming performed by multiple access points (APs). Each AP enables signals to reach only a prescribed communication area through coordinated beamforming. On the other hand, each AP enables signals not to reach only a prescribed communication area through coordinated beamforming. This suggests that the entire communication area can be divided into multiple subareas through coordinated beamforming based on cooperation among the multiple APs. By controlling communication quality for each subarea, the communication system can flexibly control Quality of service (QoS).

### CITATION LIST

### Non-Patent Literature

NPL 1: IEEE 802.11-15/0588r0 May 2015
NPL 2: Y. Takatori, et. al, “Effect of spatial resource assignment in overlapping cell,” IEICE Commun. Conf. '09, B-5-103, September 2009

### SUMMARY OF THE INVENTION

### Problems to be Solved by the Invention

The inter-AP coordinated beamforming, discussed in NPL 1 and the like, needs sharing, among the APs, of channel state information (CSI) on channels between each AP and terminal devices associated with the AP. However, sharing of the CSI among the APs needs a large amount of feedback information. Furthermore, the channel state varies momentarily in conjunction with movement of radio transmission units or changes in a surrounding environment. Thus, in a case that the APs perform coordinated beamforming based on temporally old CSI, a mismatch between the old CSI and the actual channel state may prevent the correct coordinated beamforming, thus precluding the communication area from being correctly divided into subareas.

The present invention addresses the above-described drawbacks. An object of the present invention is to provide a radio communication system in which, for an increased use efficiency of radio resources for the communication system, APs cooperatively change a CCA level to efficiently divide a communication area into multiple subareas, thus realizing flexible QoS control, and to provide a relevant base station device.

### Means for Solving the Problems

To address the above-mentioned drawbacks, a radio communication system and a base station device according to an aspect of the present invention are configured as follows.

(1) Specifically, a radio communication system according to an aspect of the present invention is a radio communication system including multiple base station devices, each of the multiple base station devices including a reception unit configured to exert a carrier sense function, wherein the multiple base station devices includes first base station devices and second base station devices, each of the first base station devices includes a control unit configured to acquire a first radio parameter common to the first base station devices, each of the second base station devices includes a control unit configured to acquire a second radio parameter common to the second base station devices, and first communication quality provided by the first radio parameter is different from second communication quality provided by the second radio parameter.

(2) The radio communication system according to an aspect of the present invention includes the radio communication system according to (1) described above, wherein at least one of the first base station devices includes a first transmission unit configured to notify other first base station devices of the first radio parameter, and at least one of the second base station devices includes a second transmission unit configured to notify other second base station devices of the second radio parameter.

(3) The radio communication system according to an aspect of the present invention includes the radio communication system according to (1) described above, wherein the multiple base station devices further includes a third base station device, and the third base station device includes a third transmission unit configured to notify at least one of the first base station devices and the second base station devices of the first radio parameter or the second radio parameter.

(4) The radio communication system according to an aspect of the present invention includes the radio communication system according to any one of (1) to (3) described above, wherein each of the first base station devices includes a first reception unit configured to exert the carrier sense function, each of the second base station devices includes a second reception unit configured to exert the carrier sense function, the first radio parameter is a first CCA level used by the first reception unit to exert the carrier sense function, and the second radio parameter is a second CCA level used by the second reception unit to exert the carrier sense function.

(5) The radio communication system according to an aspect of the present invention includes the radio communication system according to any one of (1) to (3) described above, wherein the first CCA level is higher than the second CCA level.

(6) The radio communication system according to an aspect of the present invention includes the radio communication system according to any one of (1) to (3) described above, wherein the first CCA level is lower than the second CCA level.

(7) A base station device according to an aspect of the present invention is a base station device including a reception unit configured to exert a carrier sense function, the base station device being included in multiple base station devices provided in a radio communication system, the base station device further including: a control unit configured to acquire a CCA level which is shared with other base station devices included in the multiple base station devices and which is used by the reception unit to exert the carrier sense function; and a transmission unit configured to notify the other base station devices of the CCA level.

(8) The base station device according to an aspect of the present invention includes the base station device according to (7) described above, wherein the reception unit further includes a function to perform monitoring of a communication status of communication around own base station device, and the CCA level is determined, based on information acquired through the monitoring.

### Effects of the Invention

According to the aspect of the present invention, base station devices provided in a radio communication system cooperatively change a CCA level to allow the radio communication system to efficiently divide a communication area into multiple subareas, thus realizing flexible QoS control. This enables contribution to improving frequency efficiency of the system.

### BRIEF DESCRIPTION OF DRAWINGS

FIG. 1 is a block diagram illustrating a configuration example of a radio communication device according to an aspect of the present embodiment.

FIG. 2 is a diagram illustrating a configuration example of a signal frame according to an aspect of the present embodiment.

FIG. 3 is a diagram illustrating a configuration example of a radio communication system according to an aspect of the present embodiment.

FIG. 4 is a diagram illustrating a configuration example of a radio communication system according to an aspect of the present embodiment.

FIG. 5 is a diagram illustrating a configuration example of a radio communication system according to an aspect of the present embodiment.

FIG. 6 is a diagram illustrating a configuration example of a radio communication system according to an aspect of the present embodiment.

### MODE FOR CARRYING OUT THE INVENTION

A communication system according to the present embodiment includes radio transmission devices (Access points (APs), base station devices) and multiple radio reception devices (stations (STAs), terminal devices). A network constituted of each of base station device and terminal devices is referred to as a Basic service set (BSS, management range). The base station devices and the terminal devices are collectively referred to as radio communication devices or radio devices.

The base station device and each terminal device in the BSS communicates with each other, based on Carrier sense multiple access with collision avoidance (CSMA/CA).

The present embodiment is directed to an infrastructure mode in which the base station device communicates with multiple terminal devices. However, a method according to the present embodiment may be implemented in an ad-hoc mode in which the terminal devices communicate directly with each other. In the ad-hoc mode, the BSS is formed by using a terminal device instead of the base station device. The BSS in the ad-hoc mode is also referred to as an Independent Basic Service Set (IBSS). Each of the terminal devices forming the IBSS in the ad-hoc mode may be regarded as the base station device.

In the IEEE 802.11 system (IEEE 802.11 standards), each device can transmit transmission frames (frames) of multiple frame types with a common frame format. Each of a Physical (PHY) layer, a Medium access control (MAC) layer, and a Logical Link Control (LLC) layer defines the transmission frame.

The transmission frame in the PHY layer is also referred to as a physical protocol data unit (PPDU, PHY protocol data unit, physical layer frame). The PPDU is constituted of, for example, a physical layer header (PHY header) including header information used for signal processing in the physical layer or the like, and a physical service data unit (PHY service data unit, PSDU, MAC layer frame) that is a data unit processed in the physical layer. The PSDU may be constituted of an Aggregated MPDU (A-MPDU) including aggregated multiple MAC protocol data units (MPDUs) serving as retransmission units for a radio section.

The PHY header includes reference signals such as a Short training field (STF) used for signal detection, synchronization, and the like and a Long training field (LTF) used to acquire channel information for data demodulation, and control signals such as a Signal (SIG) containing control information for data demodulation. The STF is classified into a Legacy STF (L-STF), a High throughput-STF (HT-STF), a Very high throughput-STF (VHT-STF), a High efficiency-STF (HE-STF), and the like according to a corresponding standard. Similarly, the LTF is classified into an L-LTF, an HT-LTF, a VHT-LTF, and an HE-LTF, and the SIG is classified into an L-SIG, an HT-SIG, a VHT-SIG, and an HE-SIG. The VHT-SIG is further classified into a VHT-SIG-A and a VHT-SIG-B.

According to the IEEE 802.11 standard, a modulation scheme applied to a signal with the SIG stored therein allows identification of a corresponding standard for a frame including the SIG. A terminal device compliant with the IEEE 802.11 standard can identify the corresponding standard for the frame including the SIG by measuring In-phase (I) axis power and Quadrature (Q) axis power at the PHY header.

The PHY header may further contain information identifying the BSS which is a transmission source of the transmission frame belongs (the information is hereinafter also referred to as BSS identification information). The information identifying the BSS may be, for example, a Service Set Identifier (SSID) of the BSS or a MAC address of the base station device in the BSS. The information identifying the BSS may also be a value specific to the BSS (e.g., a BSS Color) and other than the SSID and the MAC address.

The PPDU is modulated according to a corresponding standard. For example, according to the IEEE 802.11n standard, the PPDU is modulated into an Orthogonal frequency division multiplexing (OFDM) signal.

The MPDU is constituted of a MAC layer header (MAC header) containing header information for signal processing in the MAC layer or the like, a MAC service data unit (MSDU) that is a data unit processed in the MAC layer or a frame body, and a Frame check sequence (FCS) for a check of the frame for an error. Moreover, multiple MSDUs may be aggregated into an Aggregated MSDU (A-MSDU).

The frame types of the transmission frame in the MAC layer is classified into roughly three frame types of: management frames for management of the status of association or the like among the devices, control frames for management of the status of communication among the devices, and data frames containing actual transmission data. Each of the frame types is further classified into multiple subframe types. Examples of the control frame include an Acknowledge (ACK) frame, a Request to send (RTS) frame, and a Clear to send (CTS) frame. Examples of the management frame include a Beacon frame, a Probe request frame, a Probe response frame, an Authentication frame, an Association request frame, and an Association response frame. Examples of the data frame include a Data frame and a polling (CF-poll) frame. By reading the contents of the frame control field included in the MAC header, each device can determine the frame type and subframe type of the received frame.

Note that an example of the Ack frame may include a Block Ack frame. The Block Ack frame enables a reception completion notification for multiple MPDUs.

The beacon frame includes Fields describing Beacon intervals at which beacons are transmitted and the SSID. Each base station device can periodically broadcast the beacon frame into the BSS. By receiving the beacon frame, each terminal device can recognize the base station device located near the terminal device itself. Passive scanning refers to recognizing, by the terminal device, the base station device, based on the beacon frame that are broadcast by the base station device. On the other hand, Active scanning refers to probing, by the terminal device, for the base station device by broadcasting the probe request frame into the BSS. The base station device can transmit the probe response frame as a response to the probe request frame, the contents of the probe response frame being equivalent to the contents of the beacon frame.

The terminal device performs association processing on the base station device after recognizing the base station device. The association processing is classified into an Authentication procedure and an Association procedure. The terminal device transmits an authentication frame (authentication request) to the base station device with which the terminal device desires to be associated. In a case of receiving the authentication frame, the base station device transmits, to the terminal device, an authentication frame (authentication response) including a status code indicating whether the terminal device is successfully authenticated. By reading the status code contained in the authentication frame, the terminal device can determine whether the terminal device has been authenticated by the base station device. The base station device and the terminal device can exchange the authentication frames with each other multiple times.

Subsequently to the authentication procedure, the terminal device transmits an association request frame to the base station device in order to perform the association procedure. In a case of receiving the association request frame, the base station device determines whether to permit association of the terminal device, and transmits an association response frame in order to notify the terminal device of the determination. In addition to the status code indicating whether to permit the association processing, the association response frame contains an Association identifier (AID) for identifying the terminal device. The base station device can manage multiple terminal devices by configuring different AIDs for respective terminal devices to which the base station device has given association permission.

After the association processing, the base station device and the terminal device perform actual data transmission. The IEEE 802.11 system defines a Distributed Coordination Function (DCF) and a Point Coordination Function (PCF), and functions enhanced from the DCF and PCF (Enhanced distributed channel access (EDCA), a Hybrid coordination function (HCF), and the like). By way of example, a case will be described below where the base station device transmits a signal to the terminal device using the DCF.

With the DCF, the base station device and the terminal device perform Carrier sense (CS) to check a radio channel around each of the devices for usage before communication. For example, in a case of receiving, through the radio channel, a signal with a level higher than a predetermined Clear channel assessment level (CCA level), the base station device, which serves as a transmitting station, defers transmission of a transmission frame on the radio channel. Hereinafter, a Busy state refers to a state where a signal with the CCA level or higher is detected on the radio channel, and an Idle state refers to a state where no signal with the CCA level or higher is detected on the radio channel. Consequently, physical Carrier Sense (physical CS) refers to CS based on the power of a signal actually received by each device (received power level). Note that the CCA level is also referred to as a Carrier Sense level (CS level) or a CCA Threshold (CCAT). Note that, in a case of detecting a signal with the CCA level or higher, the base station device and the terminal device can start an operation of demodulating at least signals in the PHY layer. Furthermore, the base station device and the terminal device can change the carry sense operation depending on whether the received signal includes a frame based on the IEEE 802.11 standards. Signal detection carrier sense (CCA/CS) refers to carrier sense performed in a case that the base station device and the terminal device recognize that the received signals include frames based on the IEEE 802.11 standards. Power detection carrier sense (CCA/ED) refers to carrier sense performed in a case that the base station device and the terminal device fail to recognize that the received signals include frames based on the IEEE 802.11 standards.

The base station device performs carrier sense for an Inter frame space (IFS) corresponding to the type of the transmission frame to be transmitted, to determine whether the radio channel is in the busy state or in the idle state. The period when the base station device performs carrier sense varies according to the frame type and subframe type of the transmission frame to be transmitted by the base station device. The IEEE 802.11 system defines multiple IFSs with different periods including a Short IFS (SIFS) used for transmission frames provided with the highest priority, a polling IFS (PCF IFS: PIFS) used for transmission frames provided with a relatively high priority, and distributed coordination function IFS (DCF IFS: DIFS) used for transmission frames provided with the lowest priority. In a case of transmitting a data frame using the DCF, the base station device uses the DIFS.

The base station device waits for the DIFS, and then further waits for a random back-off duration provided to prevent frame collisions. The IEEE 802.11 system uses a random back-off duration referred to as a Contention window (CW). The CSMA/CA assumes that a transmission frame transmitted by a certain transmitting station is received by a receiving station in a state with no interference with other transmitting stations. Consequently, in a case that transmitting stations transmit transmission frames at the same timing, the frames collide against each other, preventing receiving stations from correctly receiving the frames. Thus, each transmitting station avoids possible frame collisions by waiting for a randomly configured duration before the start of transmission. In a case of determining, through carrier sense, that the radio channel is in the idle state, the base station device starts counting down the CW duration. Once the CW duration reaches 0, the base station device can acquire a right of transmission and transmit the transmission frame to the terminal device. In a case that the base station device determines that, through carrier sense during the countdown of the CW duration, the radio channel is in the busy state, the base station device stops counting down the CW duration. Then, in a case that the radio channel is brought into the idle state, the base station device resumes counting down the remaining portion of the CW duration following the last IFS.

The terminal device, which serves as a receiving station, receives the transmission frame, reads the PHY header of the transmission frame, and demodulates the received transmission frame. Then, the terminal device can recognize whether the transmission frame is addressed to the own terminal device by reading the MAC header of the demodulated signal. Note that the terminal device can also determine the destination of the transmission frame, based on the information contained in the PHY header (e.g., a Group identifier (Group ID, GID) indicated in VHT-SIG-A).

Each of the base station device and the terminal device include an internal parameter referred to as a Receiver minimum input sensitivity. The base station device and the terminal device need to demodulate frames received with received power at a specified receiver minimum input sensitivity or higher in such a manner as that the frame satisfies preset reception quality (e.g., an average Packet error rate (PER) of 10% or less). The IEEE 802.11 standards define the receiver minimum input sensitivity for each Modulation and coding rate set (MCS) applied to the PPDU. For example, in the IEEE 802.11ac standard, a frame modulated using an MCS0 (BPSK modulation, a coding rate of ½), which provides the minimum frequency efficiency, has a receiver minimum input sensitivity of −82 dBm in a communication bandwidth of 20 MHz. Conversely, the base station device and the terminal device compliant with the IEEE 802.11 ac standard need not necessarily demodulate frames received with received power at less than −82 dBm/20 MHz.

In a case of determining that the received transmission frame is addressed to the own terminal device and having successfully demodulated the transmission frame with no errors, the terminal device needs to transmit, to the base station device, which serves as a transmitting station, an ACK frame indicating that the frame has been correctly received. The ACK frame is one of transmission frames with the highest priority transmitted without standing by except during the SIFS period (with no random back-off duration). The base station device ends a series of communications upon reception of the ACK frame transmitted from the terminal device. In a case of failing to correctly receive the frame, the terminal device does not transmit the ACK. Therefore, in a case of not having received the ACK frame from the receiving station for a given period (SIFS+ACK frame length) following transmission of the frame, the base station device presumes that the communication has failed and ends the communication. Note that the base station device can perform an Automatic repeat request (ARQ) operation for retransmission of a previously transmitted frame. As described above, the end of one communication (also referred to as a burst) in the IEEE 802.11 system is inevitably determined based on whether the ACK frame has been received, except in special cases such as transmission of a broadcast signal such as the beacon frame and the use of fragmentation for division of transmission data.

In a case of determining that the received transmission frame is not addressed to the own terminal device, the terminal device configures a Network allocation vector (NAV), based on the Length of the transmission frame indicated in the PHY header and the like. The terminal device does not try communication during the period configured as the NAV. To be more precise, the terminal device performs, during the period configured as the NAV, the same operation as that performed in a case of determining by the physical CS that the radio channel is in the busy state, and thus, communication control based on the NAV is also referred to as virtual carrier sense (virtual CS). The NAV may be configured not only based on the information contained in the PHY header but also using a Request to send (RTS) frame and a Clear to send (CTS) frame, which are introduced to solve a hidden terminal problem. Note that this does not necessarily indicate that the terminal device is prevented from performing a receiving operation during the period configured as the NAV.

Compared to the DCF, which allows each device to perform carrier sense to autonomously acquire the right of transmission, the PCF allows a control station referred to as a Point coordinator (PC) to control the right of transmission of each device in the BSS. In general, the base station device serves as the PC to acquire the right of transmission in the BSS and to control the right of transmission of each terminal device in the BSS.

The communication period using the PCF includes a Contention free period (CFP) and a Contention period (CP). During the CP, communication is performed based on the above-described DCF. Thus, the PC controls the right of transmission during the CFP. The base station device, which serves as the PC, broadcasts the beacon frame indicating the duration of the CFP (CFP Max duration) and the like, into the BSS, before communication using the PCF. Note that the PIFS is used to transmit a beacon frame that is broadcast at the start of transmission using the PCF and the beacon frame is transmitted without standing by for the CW duration. In a case of receiving the beacon frame, the terminal device configures, as the NAV, the duration of the CFP indicated in the beacon frame. Subsequently, the terminal device can acquire the right of transmission only in a case of receiving a signal for signaling (e.g., a data frame including CF-poll) transmitted by the PC and indicating acquisition of the right of transmission until the NAV period passes or a signal (e.g., a data frame including CF-end) broadcasting the end of the duration of the CFP into the BSS is received. Note that no packet collision occurs within the same BSS during the duration of the CFP, and thus, each terminal device provides no random back-off duration used for the DCF.

The APs and the STAs may include, in a Maximum A-MPDU Length Exponents subfield, information on the maximum aggregation number of receivable A-MPDUs (maximum A-MPDU length). The information contained in the Maximum A-MPDU Length Exponents subfield is an integer value. In a case that the integer value is X, the APs and the STAs can receive a frame provided with an A-MPDU with a length of 2̂(13+X)−1 octes. The AP and STA serving as transmission-source terminal devices are not allowed to transmit, to the AP and STA serving as destination terminal devices, any frames provided with an A-MPDU with a length exceeding the maximum A-MPDU length that can be received by the AP and STA serving as destination terminal devices.

The APs and the STAs may include, in a Max Number Of MSDUs In A-MSDU subfield or a Maximum A-MSDU Length field, the maximum aggregation number of receivable A-MSDUs (maximum A-MSDU length). The Max Number Of MSDUs In A-MSDU is information indicating the number of aggregatable MSDUs. The Maximum A-MSDU Length is information indicating the receivable A-MSDU length per se. The AP and STA serving as transmission-source terminal devices are not allowed to transmit, to the AP and STA serving as destination terminal devices, any frames provided with an A-MSDU with a length exceeding the maximum A-MSDU length that can be received by the AP and STA serving as destination terminal devices.

The AP and the STA may each be provided with a function to feed back channel state information (CSI) on the channel state observed by the AP or the STA. In this regard, each of the AP and the STA may be provided with a function to request the terminal device associated with the own AP or the STA to feed back the CSI.

The base station devices and the terminal devices are also collectively referred to below as radio communication devices. Moreover, information exchanged between one radio communication device and another radio communication device when the radio communication devices communicate with each other is also referred to as data. To be more precise, the radio communication devices include the base station devices and the terminal devices.

The Ack and the BA may also be referred to as responses (response frames). Moreover, the probe response, the authentication response, and the association response may be referred to as responses.

### 1. First Embodiment

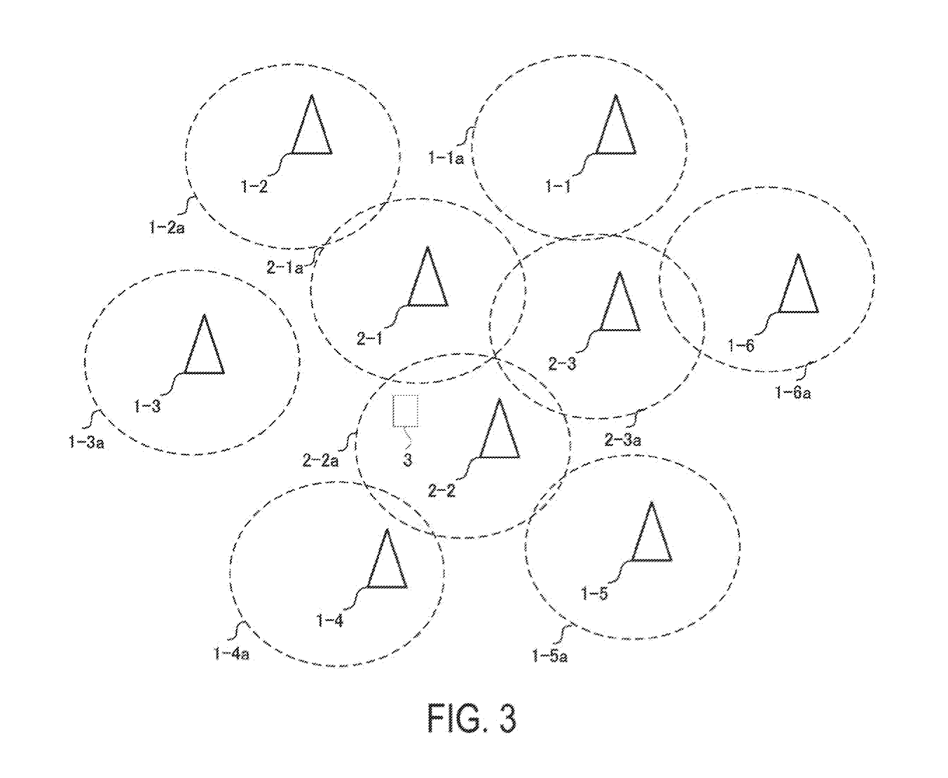

FIG. 3 is a diagram illustrating an example of a radio communication system according to the present embodiment. The radio communication system includes radio communication devices 1-1 to 1-6, radio communication devices 2-1 to 2-3, and a radio communication device 3. Note that all or some of the radio communication devices 1-1 to 1-6 are also referred to as the radio communication device(s) 1. Similarly, all or some of the radio communication devices 2-1 to 2-3 are also referred to as the radio communication device(s) 2. Moreover, the radio communication device 1 is also referred to as the base station device 1 (first base station device), the radio communication device 2 is also referred to as the base station device 2 (second base station device), and the radio communication device 3 is also referred to as the terminal device 3. Furthermore, the base station device 1 and the base station device 2 are also collectively simply referred to as the base station device. The terminal device 3 can be associated with any of the base station devices by radio and can transmit and receive PPDUs to and from the associated base station device.

The base station devices include management ranges denoted as 1-1a to 1-6a and 2-1a to 2-3a. In general, the terminal device 3 positioned within the management range of a certain base station device can be associated with the base station device providing the management range. Note that the size of the management range illustrated in FIG. 3 is only illustrative, and e.g., partly overlapping management ranges are also included in the present embodiment. The numbers of base station devices and terminal devices included in the radio communication system are also not limited to the values in the example in FIG. 3.

Note that, although, in the example illustrated in FIG. 3, the base station devices form different BSSs, this does not necessarily mean different Extended Service Sets (ESSs). For example, some of the base station devices illustrated in FIG. 3 can constitute a common ESS. The ESS refers to a service set forming a Local Area Network (LAN). To be more precise, the radio communication devices belonging to the same ESS may be regarded by a higher layer to belong to the same network. Multiple BSSs belonging to a prescribed ESS may use common radio parameters (e.g., a carrier frequency) but do not need to use common radio parameters. Note that a communication area that can be provided by the radio communication system including the base station devices 1 and the base station devices 2 is also referred to as a communication area of the radio communication system.

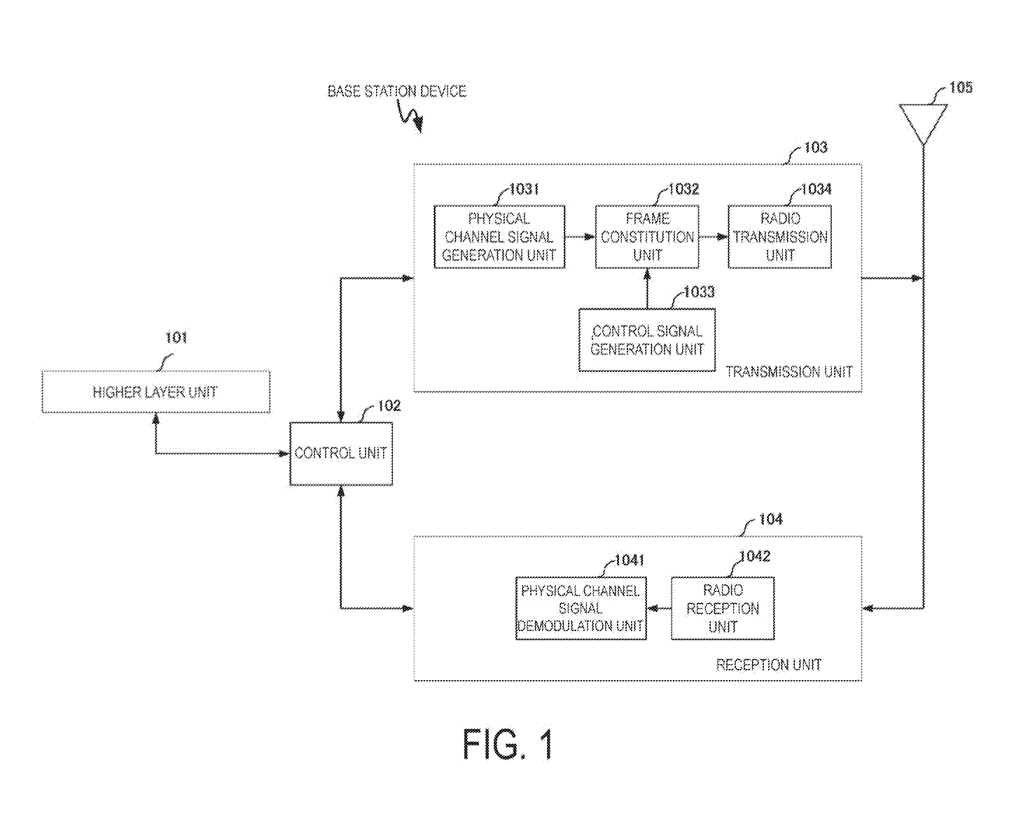

FIG. 1 is a block diagram illustrating an example of a device configuration of a base station device according to the present embodiment. As illustrated in FIG. 1, the base station device includes a higher layer unit 101, a control unit 102, a transmission unit 103, a reception unit 104, and an antenna 105. Note that a method described below is applicable to a case where the terminal device 3 transmits a frame to the base station device. In other words, an example of a configuration of the terminal device 3 according to the present embodiment is as illustrated in the block diagram in FIG. 1.

The higher layer unit 101 performs processing for a medium access control layer and the like. Furthermore, the higher layer unit 101 generates information for control of the transmission unit 103 and the reception unit 104, and outputs the generated information to the control unit 102. The control unit 102 controls the higher layer unit 101, the transmission unit 103, and the reception unit 104.

Furthermore, the transmission unit 103 includes a physical channel signal generation unit 1031, a frame constitution unit 1032, a control signal generation unit 1033, and a radio transmission unit 1034. The physical channel signal generation unit 1031 generates a baseband signal transmitted to the terminal device 3 by the base station device. Signals generated by the physical channel signal generation unit 1031 contain a Training field (TF) used for channel estimation by each STA and data transmitted in MSDUs.

The frame constitution unit 1032 multiplexes a signal generated by the physical channel signal generation unit 1031 and a signal generated by the control signal generation unit 1033 to constitute a transmission frame for the baseband signal actually transmitted by an AP 1.

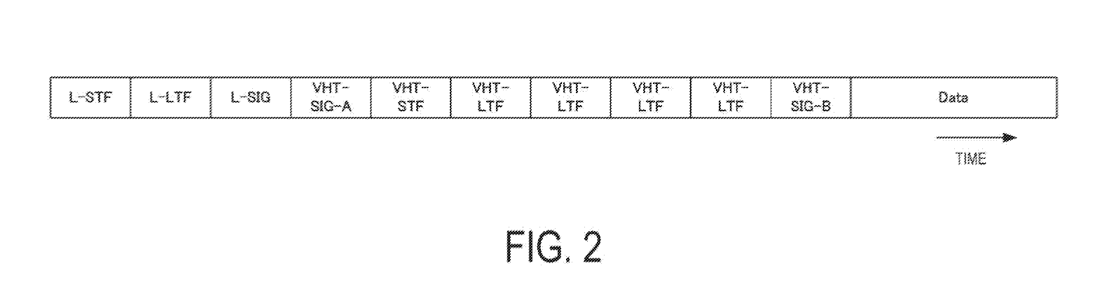

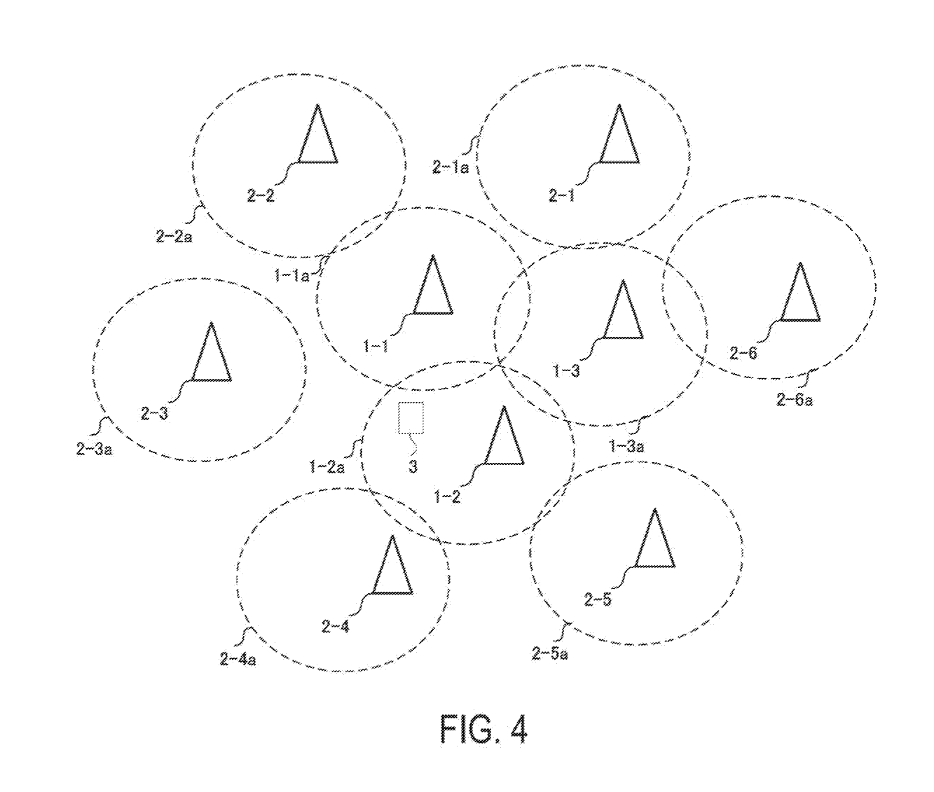

FIG. 2 is a schematic diagram illustrating an example of the transmission frame generated by the frame constitution unit 1032 according to the present embodiment. The transmission frame contains reference signals such as L-STF, L-LTF, VHT-STF, and VHT-LTF. The transmission frame also contains control information such as L-SIG, VHT-SIG-A, and VHT-SIG-B. The transmission frame contains a Data section. The constitution of the transmission frame generated by the frame constitution unit 1032 is not limited to the constitution illustrated in FIG. 4. The transmission frame may contain another type of control information (e.g., HT-SIG), a reference signal (e.g., HT-LTF), or the like. Moreover, the transmission frame generated by the frame constitution unit 1032 need not contain all of the signals such as L-STF and VHT-SIG-A. Note that the control information contained in L-SIG or the like is information needed to demodulate the Data section and is thus hereinafter also referred to as the physical header (PHY header).

The transmission frame generated by the frame constitution unit 1032 is classified into some frame types. For example, the frame constitution unit 1032 can generate three frame types of transmission frames: management frames for management of the status of association or the like among the devices, control frames for management of the status of communication among the devices, and data frames including actual transmission data. The frame constitution unit 1032 may contain information indicative of the frame type to which the generated transmission frame belongs, in the MAC header to be transmitted in the Data section.

The radio transmission unit 1034 performs processing for converting the baseband signal generated by the frame constitution unit 1032 into a signal in a Radio frequency (RF) band. The processing performed by the radio transmission unit 1034 includes digital-analog conversion, filtering, frequency conversion from the baseband to the RF band, and the like.

The antenna 105 transmits a signal generated by the transmission unit 103 to the terminal device 3.

The base station device also includes a function to receive a signal transmitted from the terminal device 3. The antenna 105 receives the signal transmitted from the terminal device 3 and outputs the signal to the reception unit 104.

The reception unit 104 includes a physical channel signal demodulation unit 1041 and a radio reception unit 1042. The radio reception unit 1042 converts a signal in the RF band received through the antenna 105 into a signal in the baseband. Processing performed by the radio reception unit 1042 includes frequency conversion from the RF band to the baseband, filtering, analog-digital conversion, and the like. The processing performed by the reception unit 104 may also include a (carrier sense) function to measure surrounding interference in a specific frequency band to secure the frequency band.

The physical channel signal demodulation unit 1041 demodulates the signal in the baseband output by the radio reception unit 1042. The signal demodulated by the physical channel signal demodulation unit 1041 is a signal transmitted by the terminal device 3 through an upstream (uplink) and having similar same frame constitution to frame constitution of a data frame generated by the frame constitution unit 1032. Therefore, the physical channel signal demodulation unit 1041 can demodulate uplink data on a data channel, based on control information transmitted on a control channel for the data frame. The physical channel signal demodulation unit 1041 may also include a carrier sense function. Note that the reception unit 104 may input signal power in the frequency band into the higher layer unit 101 via the control unit 102 and that the higher layer unit 101 may perform processing associated with carrier sense.

A function to change the CCA level is provided in the reception unit 104 (first reception unit) or higher layer unit 101 included in the base station device 1 according to the present embodiment, and also provided in the reception unit 104 (second reception unit) or higher layer unit 101 included in the base station device 2. The CCA levels changed by the function to change the CCA level include a CCA level requiring preamble detection (CCA/CS level) and a CCA level not requiring preamble detection (CCA/ED level). The base station device 1 and the base station device 2 according to the present embodiment further includes a function to perform carrier sense (CCA), based on the CCA level configured by the function to change the CCA level. The carrier sense performed by the function to perform carrier sense includes carrier sense based on the CCA/CS level and carrier sense based on the CCA/ED level.

The base station devices 1 according to the present embodiment can cooperatively change the CCA level. For example, the base station devices 1-1 to 1-6 can perform carrier sense using a common CCA level. Similarly, the base station devices 2 according to the present embodiment can cooperatively change the CCA level. For example, the base station devices 2-1 to 2-3 can perform carrier sense using a common CCA level.

The CCA level commonly used by the base station devices 1 (first CCA level) may have a value different from a value of the CCA level commonly used by the base station devices 2 (second CCA level). The base station devices 1 can perform carrier sense (first carrier sense) or CCA (first CCA), based on the first CCA level. Similarly, the base station devices 2 can perform carrier sense (second carrier sense) or CCA (second CCA), based on the second CCA level.

Each base station device 1 and each base station device 2 may perform different types of carrier sense. For example, the reception unit 104 of the base station device 1 can perform CCA/CS, whereas the reception unit 104 of the base station device 2 can perform CCA/ED.

The radio communication system can configure the first CCA level for each base station device 1 in advance. The base station device 1 may also include a function to acquire the first CCA level. The function may be provided, for example, in the first reception unit. Moreover, any one (e.g., the base station device 1-1) of the base station devices 1 can notify each base station device 1 of the first CCA level. In other words, the transmission unit 103 (first transmission unit) included in the base station device 1 according to the present embodiment includes a function to notify the other base station devices 1 of the first CCA level.

The radio communication system can configure the second CCA level for each base station device 2 in advance. The base station device 2 may also include a function to acquire the second CCA level. The function may be provided, for example, in the second reception unit. Moreover, any one (e.g., the base station device 2-1) of the base station devices 2 can notify each base station device 2 of the second CCA level. In other words, the transmission unit 103 (second transmission unit) included in the base station device 2 according to the present embodiment includes a function to notify the other base station devices 2 of the second CCA level.

The base station device 1 according to the present embodiment includes a function to monitor the communication status of communication around the own base station device 1. The function to monitor the communication status may be provided, for example, in the reception unit 104 of the base station device 1. The base station device 1 can acquire the first CCA level, based on the information acquired by the function to monitor the communication status. The base station device 1 can then notify the other base station devices of the first CCA level. Here, examples of information included in the communication status include, but not limited to, interference power within the management range of the base station device 1, a traffic amount, the number of associated terminals, and a radio medium occupancy time. The above-described operations can also be performed by the base station device 2 according to the present embodiment and a radio communication device 4 described below.

Moreover, the communication system may further include the radio communication device 4 (third base station device). The third base station device may include a transmission unit (third transmission unit) including a function to notify the base station device 1 or the base station device 2 of the first CCA level or the second CCA level. The third base station device may use any type of frame to notify the base station device 1 or the base station device 2 of the first CCA level or the second CCA level. Note that the functions of the third base station device may be provided in the first base station device or the second base station device, or the third base station device may be provided with the functions of the first base station device or the second base station device.

The above-described method enables each base station device 1 to perform carrier sense, based on the common first CCA level. Moreover, each base station devices 2 can perform carrier sense, based on the common second common CCA level. The first CCA level and the second CCA level may be configured to have different values.

In the communication system according to the present embodiment, the first CCA level may be configured to have a value larger than the value of the second CCA level. In this case, in the communication system, the base station devices 1 having a higher CCA level, surround the base station devices 2 having a lower CCA level. The base station devices 1 having the higher CCA level, have a larger threshold at which a channel is determined through carrier sense to be in the idle state, than the base station device 2 having the lower CCA level, and thus have a higher Transmission opportunity (TXOP) acquisition rate than the base station devices 2 having the lower CCA level. In other words, the base station devices 1 can provide communication services with lower latency than the base station devices 2. On the other hand, the base station devices 2 have a smaller threshold at which a channel is determined through carrier sense to be in the idle state, than the base station device 1. Thus, frames transmitted by the base station devices 2 are likely to be received by the destination terminal devices in a higher Signal-to-interference plus noise power ratio (SINR) than frames transmitted by the base station devices 1. In other words, the base station devices 2 can provide more reliable communication services than the base station devices 1.

In summary, the base station devices 1 use the higher CCA level than the base station devices 2, and thus the radio communication system can divide the communication area included in the radio communication system into two subareas: the communication area where the reliable communication services can be provided and the communication area where the low-latency communication services can be provided. By way of example, for the base station devices 1 and the base station devices 2 as illustrated in FIG. 3, the communication area included in the radio communication system is configured in such a manner that the area of the reliable communication services, provided by the base station devices 2, surrounds the area of the low-latency communication services, provided by the base station devices 1.

For such a radio communication system, for example, in an event site or the like, the base station devices 2 may be densely arranged at a location such as a reception area or an admission gate where the terminal devices 3 may gather densely. On the other hand, in the radio communication system, the base station devices 1 are less densely arranged within the site to enable high-quality communication services to be provided to the terminal devices 3.

Moreover, as illustrated in FIG. 4, the radio communication system can employ a device arrangement in such a manner that the base station devices 2-1 to 2-6 surround the base station devices 1-1 to 1-3. In this case, the communication area included in the radio communication system is constituted in such a manner that the area of the low-latency communication services, provided by the base station devices 1, is surrounded by the area of the high-quality communication services, provided by the base station devices 2.

Such a radio communication system can provide, e.g., sensor network services involving a mixture of sensor terminals with different notification data. For example, in a possible situation in a large-scale farm, observation sensors transmitting a small amount of observation data such as ambient temperature sensors or water temperature sensors are arranged within the farm, whereas surveillance cameras surround the farm in order to sense an abnormality within the farm such as invasion of a prowler. In this case, in the radio communication system as illustrated in FIG. 4, the base station devices 1, arranged within the farm, can acquire, through low-latency communication, data provided by the observation sensors, whereas the base station devices 2, surrounding the farm, can acquire, through reliable communication, video data provided by the surveillance cameras, surrounding the farm.

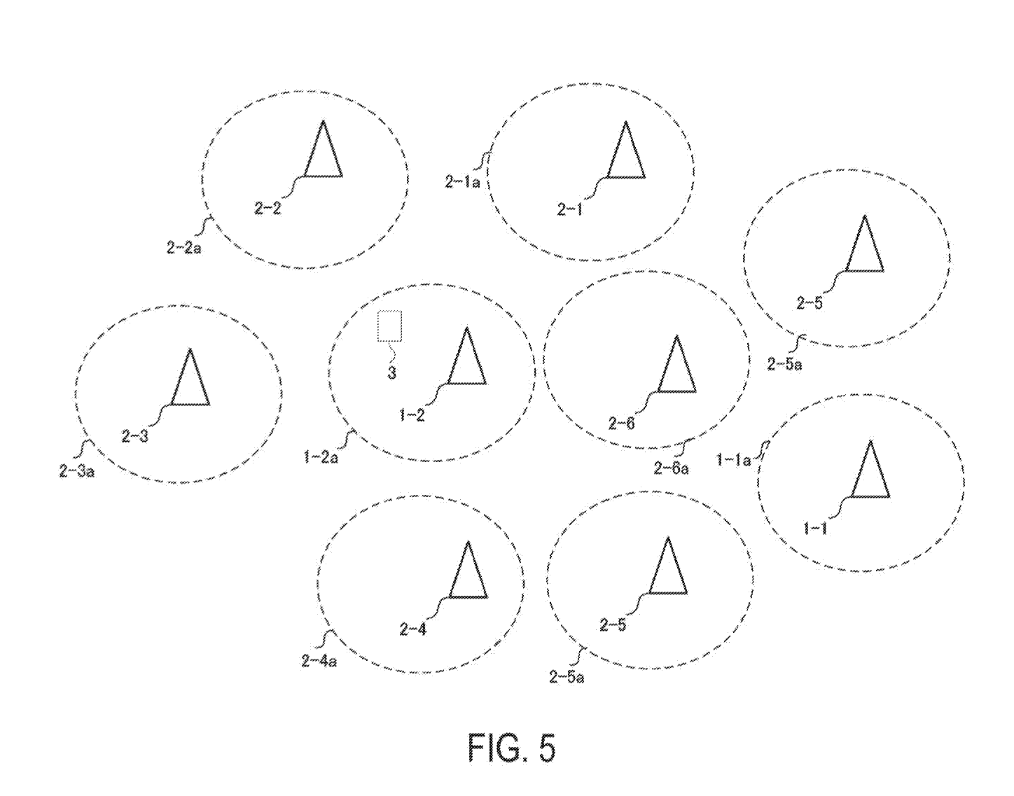

Moreover, as illustrated in FIG. 5, the radio communication system can employ a device arrangement in such a manner that the base station devices 2-1 to 2-6 are arranged to form a plane region and the base station devices 1-1 and 1-2 are dispersedly provided in the plane region. In this case, the communication area included in the radio communication system is constituted such that the areas of the high-quality communication services, provided by the base station devices 2, are arranged to form a plane region, and the areas of the low-latency communication services, provided by the base station devices 1, are dispersedly provided in the plane region.

Such a radio communication system can provide, e.g., hot spot services. The host spot refers to a limited communication area where a specific communication service can be provided. By way of example, as illustrated in FIG. 5, the radio communication system can provide the low-latency communication services only to the terminal device 3 located in the communication area (1-1a and 1-2a) of the base station devices 1. The radio communication system can efficiently provide the hot spot services to the terminal device 3 by providing positional information on the base station devices 1 to the terminal device 3 in advance.

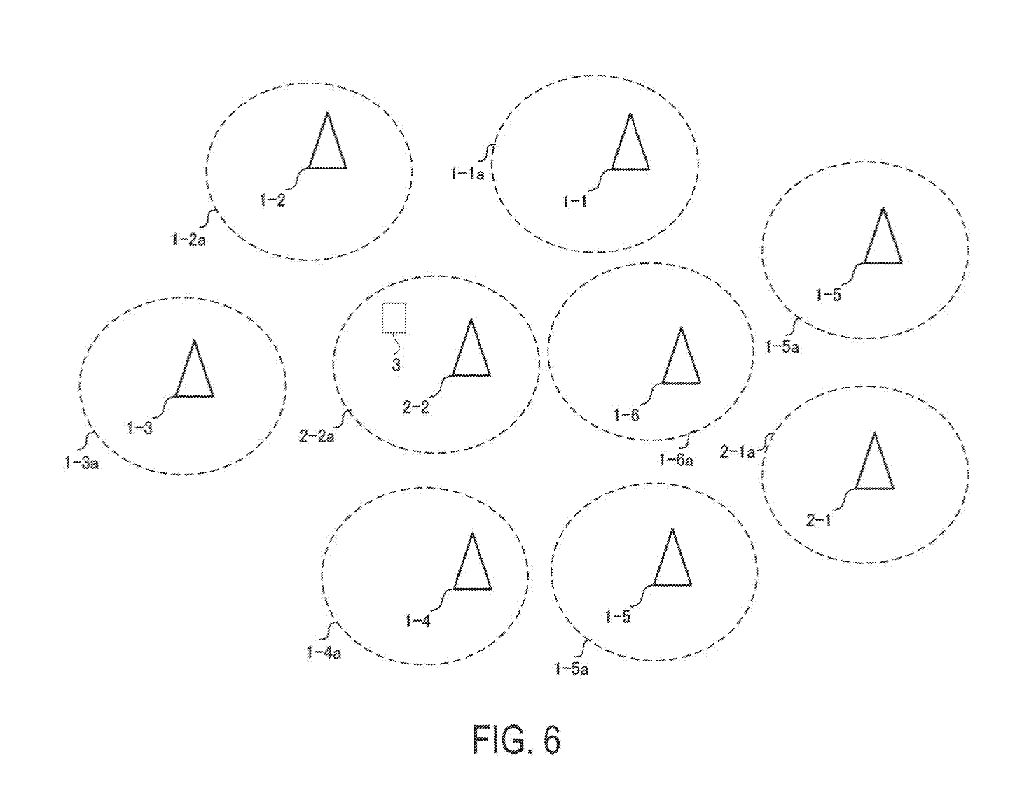

Alternatively, as illustrated in FIG. 6, the radio communication system can employ a device arrangement in such a manner that the base station devices 1-1 to 1-6 are arranged to form a plane region and the base station devices 2-1 and 2-2 are dispersedly provided in the plane region. In this case, the communication area included in the radio communication system is constituted such that the areas of the low-latency communication services, provided by the base station devices 1, are arranged to form a plane region, and the areas of the reliable communication services, provided by the base station devices 2, are dispersedly provided in the plane region.

Such a radio communication system may, e.g., configure a grade for the terminal devices 3 included in the radio communication system in advance. Here, the grade refers to information indicative of communication quality that can be received by the terminal devices 3 for which the grade is configured. For example, the terminal devices 3 for which a low grade is configured are provided only with low-quality communication services, whereas the terminal devices 3 for which a high grade is configured are provided with high-quality communication services.

Such a radio communication system as illustrated in FIG. 6 can exclusively permit the terminal devices 3 for which the high grade is configured, to be associated with the base station devices 2. Note that the radio communication system can permit the terminal devices 3 for which any grade is configured, to be associated with the base station devices 1. Such control enables the radio communication system to provide reliable communication services for the terminal devices 3 for which the high grade is configured. Note that, in the case described above, the reliable communication services are provided as the high-quality communication services, by way of example. Depending on the contents of the communication services provided by the radio communication system, some low-latency communication services may serve as high-quality communication services. In this case, the radio communication system can exclusively permit the terminal devices 3 for which the high grade is configured to be associated with the base station devices 1.

According to the method described above, the radio communication system is provided with the base station devices 1 and 2, having the different carrier sense levels, and thus the communication area can include the area where the low-latency communication services can be provided and the area where the reliable communication services can be provided. Therefore, the radio communication system can flexibly control QoS in the communication areas.

According to the method described above, the base station devices 1 acquire the common CCA level (first CCA level) as the common radio parameter (first radio parameter). On the other hand, the base station devices 2 acquire the common CCA level (second CCA level) as the common radio parameter (second radio parameter). The first radio parameter and the second radio parameter commonly acquired by the base station devices 1 and the base station devices 2 according to the present embodiment, respectively, are not limited to the CCA levels. With the first radio parameter and the second radio parameter according to the present embodiment, the quality of the communication services provided by the base station devices 1, which use the first radio parameter, is different from the quality of the communication services provided by the base station devices 2, which use the second radio parameter.

For example, the base station devices 1 can acquire a common receiver minimum input sensitivity (first receiver minimum input sensitivity) as the first radio parameter. Then, the reception unit 104 of each base station device 1 can perform reception processing, based on the first receiver minimum input sensitivity. The base station devices 2 can acquire a common receiver minimum input sensitivity (second receiver minimum input sensitivity) as the second radio parameter. Then, the reception unit 104 of each base station device 2 can perform reception processing, based on the second receiver minimum input sensitivity. In the radio communication system, the first receiver minimum input sensitivity may be configured to have a value different from a value of the second receiver minimum input sensitivity.

Note that the first radio parameter and the second parameter may be information relating to transmit power, IFS configuration information (e.g., information used to configure a period of waiting in the IFS), and back-off configuration information (information used to configure a period of waiting for the back-off duration or information on a method for determining the number of back-off slots (e.g., information for configuration of an upper limit or a lower limit for the back-off slots)), or the like.

For example, in a case that each of the first radio parameter and the second radio parameter is a communication bandwidth or the number of transmit antennas, each base station device 1 can provide communication services with a higher throughput than each base station device 2 by using a larger communication bandwidth or a larger number of transmit antennas than the base station device 2.

For example, in a case that each of the first radio parameter and the second radio parameter is an insertion density of pilot signals in a time direction, each base station device 1 can provide communication services with a higher resistant for high-speed movement than each base station device 2 by using a higher insertion density of pilot signals in the time direction than the base station device 2.

Moreover, in the described method, the radio communication system includes the two types of base station devices: the first base station devices, which acquire the first CCA level, and the second base station devices, which acquire the second CCA level. However, the radio communication system according to the present embodiment may further include a third base station device acquiring a CCA level different from the first CCA level and from the second CCA level and may of course be provided with four or more types of base station devices. Such a radio communication system can flexibly divide the communication area included in own system into subareas. In the radio communication system that may include three or more types of base station devices as described above, the radio parameter acquired by each base station device is, needless to say, not limited to the CCA level.

In the radio communication system described above, the multiple base station devices cooperatively acquire the common CCA level and perform carrier sense, based on the CCA level, and thus the radio communication system can flexibly divide the communication area provided by the own system into subareas. Furthermore, the subareas enable provision of radio communication services providing different types of communication quality. Therefore, the radio communication system according to the present embodiment can flexibly control the QoS in the communication areas and thus contribute to improving frequency efficiency.

### 2. Common to all Embodiments

A program running on each of the base station device and the terminal device according to an aspect of the present invention is a program (a program for causing a computer to operate) that controls a CPU and the like in such a manner as to realize the functions according to an aspect of the above-described embodiments of the present invention. The information handled by these devices is temporarily held in a RAM at the time of processing, and is then stored in various types of ROMs, HDDs, and the like, and read out by the CPU as necessary to be edited and written. Here, a semiconductor medium (a ROM, a non-volatile memory card, or the like, for example), an optical recording medium (DVD, MO, MD, CD, BD, or the like, for example), a magnetic recording medium (a magnetic tape, a flexible disk, or the like, for example), and the like can be given as examples of recording media for storing the programs. In addition to realizing the functions of the above-described embodiments by performing loaded programs, functions according to an aspect of the present invention can be realized by the programs running cooperatively with an operating system, other application programs, or the like in accordance with instructions included in those programs.

In a case of delivering these programs to market, the programs can be stored in a portable recording medium, or transferred to a server computer connected via a network such as the Internet. In this case, storage devices in the server computer are also included in an aspect of the present invention. Furthermore, some or all portions of each of the terminal device and the base station device in the above-described embodiments may be realized as LSI, which is typically an integrated circuit. The functional blocks of each of the base station device and the terminal device may be individually realized as chips, or may be partially or completely integrated into a chip. In a case that the functional blocks are integrated into a chip, an integrated circuit control unit for controlling them is added.

The circuit integration technique is not limited to LSI, and the integrated circuits for the functional blocks may be realized as dedicated circuits or a multi-purpose processor. Furthermore, in a case where with advances in semiconductor technology, a circuit integration technology with which an LSI is replaced appears, it is also possible to use an integrated circuit based on the technology.

Note that the invention of the present patent application is not limited to the above-described embodiments. The base station device and the terminal device according to the invention of the present patent application are not limited to the application in the mobile station device, and, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

The embodiments of the invention have been described in detail thus far with reference to the drawings, but the specific configuration is not limited to the embodiments. Other designs and the like that do not depart from the essential spirit of the invention also fall within the scope of the claims.

### INDUSTRIAL APPLICABILITY

The present invention is suitably used for radio communication systems.

The present international application claims priority based on JP 2015-227482 filed on Nov. 20, 2015, and all the contents of JP 2015-227482 are incorporated in the present international application by reference.

### DESCRIPTION OF REFERENCE NUMERALS

1-1, 1-2, 1-3, 1-4, 1-5, 1-6, 2-1, 2-2, 2-3, 2-4, 2-5, 2-6, 3, 4 Radio communication device
1-1a, 1-2a, 1-3a, 1-4a, 1-5a, 1-6a, 2-1a, 2-2a, 2-3a, 2-4a, 2-5a, 2-6a Management range
101 Higher layer unit
102 Control unit
103 Transmission unit
1031 Physical channel signal generation unit
1032 frame constitution unit
1033 Control signal generation unit
1034 Radio transmission unit
104 Reception unit
1041 Physical channel signal demodulation unit
1042 Radio reception unit
105 Antenna

1. A radio communication system comprising multiple base station devices, each of the multiple base station devices including a reception unit configured to exert a carrier sense function, wherein
the multiple base station devices include first base station devices and second base station devices,
each of the first base station devices includes a control unit configured to acquire a first radio parameter common to the first base station devices,
each of the second base station devices includes a control unit configured to acquire a second radio parameter common to the second base station devices, and
first communication quality provided by the first radio parameter is different from second communication quality provided by the second radio parameter.

2. The radio communication system according to claim 1, wherein
at least one of the first base station devices includes a first transmission unit configured to notify other first base station devices of the first radio parameter, and
at least one of the second base station devices includes a second transmission unit configured to notify other second base station devices of the second radio parameter.

3. The radio communication system according to claim 1, wherein
the multiple base station devices further include a third base station device, and
the third base station device includes a third transmission unit configured to notify at least one of the first base station devices and the second base station devices of the first radio parameter or the second radio parameter.

4. The radio communication system according to claim 1, wherein
each of the first base station devices includes a first reception unit configured to exert the carrier sense function,
each of the second base station devices includes a second reception unit configured to exert the carrier sense function,
the first radio parameter is a first CCA level used by the first reception unit to exert the carrier sense function, and
the second radio parameter is a second CCA level used by the second reception unit to exert the carrier sense function.

5. The radio communication system according to claim 4, wherein the first CCA level is higher than the second CCA level.

6. The radio communication system according to claim 4, wherein the first CCA level is lower than the second CCA level.

7. A base station device comprising a reception unit configured to exert a carrier sense function, the base station device being included in multiple base station devices provided in a radio communication system, the base station device further comprising:
a control unit configured to acquire a CCA level which is shared with other base station devices included in the multiple base station devices and which is used by the reception unit to exert the carrier sense function; and
a transmission unit configured to notify the other base station devices of the CCA level.

8. The base station device according to claim 7, wherein
the reception unit further includes a function to perform monitoring of a communication status of communication around own base station device, and the CCA level is determined, based on information acquired through the monitoring.
